(19) United States
(12) Patent Application Publication
(10) Pub. No.: US 2012/0256890 A1
(43) Pub. Date: Oct. 11, 2012

(54) DISPLAY MODULE AND METHOD FOR MANUFACTURING DISPLAY MODULE

(75) Inventors: Ryoh Araki, Osaka (JP); Shigenori Tanaka, Osaka (JP)

(73) Assignee: SHARP KABUSHIKI KAISHA, Osaka (JP)

(21) Appl. No.: 13/517,391

(22) PCT Filed: Aug. 31, 2010
(86) PCT No.: PCT/JP2010/064821

§ 371 Date: Jun. 20, 2012

(30) Foreign Application Priority Data
Dec. 24, 2009 (JP) 2009-293296

(51) Int. Cl. G09G 5/00; G09G 5/10; H01J 9/24; G09G 3/36

(52) U.S. Cl. 345/204; 345/690; 445/24; 345/102

(57) ABSTRACT

Disclosed is a display module in which a misalignment inspection can be instantly performed by a visual check. Also disclosed is a method for manufacturing the display module. The display module according to the present invention is provided with: a liquid crystal panel (1); a protective plate (2) that is provided with the liquid crystal panel (1) on the surface thereof; and a display control unit (3) that controls the liquid crystal panel (1) to display alignment marks (1a, 1b). The protective plate (2) is provided with alignment marks (2a, 2b, 2c, 2d).

### TECHNICAL FIELD

The present invention relates to a display module and to a method for manufacturing a display module. The present invention relates to a display module such as a liquid crystal display, a plasma display, and an electroluminescent display, for example, and relates to a method for manufacturing such.

### BACKGROUND ART

A liquid crystal panel in a mobile device such as a mobile phone is often provided with a protective plate made of a hardened glass or an acrylic plate so as to protect the liquid crystal panel from external shocks.

On the other hand, as a method of detecting misalignment that occurs when two objects are bonded together, Patent Document 1 describes a semiconductor mounting structure and its inspection method that make it possible to detect degrees of misalignment between a substrate and a semiconductor chip, which occurs in mounting the semiconductor chip on the substrate, in two different directions by inspecting the mounting substrate from the rear side thereof. In this inspection method, misalignment is detected by a method of taking an X-ray radiograph or the like from the rear side of the mounting substrate.

Patent Document 2 describes a technique of properly positioning a pixel electrode substrate and a microlens substrate to each other, which constitute a liquid crystal display panel, in accordance with their respective alignment reference points. Patent Document 3 describes a technique of bonding a support substrate including light-emitting elements and a support substrate including a black matrix by using alignment marks provided on the two substrates.

### RELATED ART DOCUMENTS

### Patent Documents

Patent Document 1: Japanese Patent Application Laid-Open Publication 2004-77386 (published on Mar. 11, 2004)

Patent Document 2: Japanese Patent Application Laid-Open Publication 2001-305519 (published on Oct. 31, 2001)

Patent Document 3: Japanese Patent Application Laid-Open Publication 2002-221916 (published on Aug. 9, 2002)

### SUMMARY OF THE INVENTION

### Problems To Be Solved By the Invention

A technique of bonding a protective plate and a liquid crystal panel by an optical resin or an optical double-sided tape has been widely adopted for improved visibility. In this technique, which includes a step of bonding a protective plate and a liquid crystal panel to each other, an efficient inspection method to prevent display anomalies caused by misalignment that occurs in a bonding step has been sought after. Also, in mounting a liquid crystal panel on a backlight, an efficient inspection method to detect misalignment that occurs in a bonding step has been sought after. However, if the position relation between a protective plate and a liquid crystal panel is to be measured every time by an electron microscope or the like, a takt time of the inspection process would become longer.

A method of measuring the position relation between a protective plate and a liquid crystal panel is described with reference to FIG. 6. FIG. 6 is a schematic view of a liquid crystal module for explaining a method of measuring the position relation between a protective plate and a liquid crystal panel.

FIG. 6(a) is a front view of a liquid crystal module 50, FIG. 6(b) is a side view of the liquid crystal module 50, and FIG. 6(c) is a top view of the liquid crystal module 50.

As shown in FIGS. 6(a) to 6(c), a protective plate 52 is attached to a liquid crystal panel 51. Next, the respective lengths of arrows 53a, 53b, 53c, and 53d are measured by using an electron microscope or the like so as to detect misalignment between the liquid crystal panel 51 and the protective plate 52. With this method, it is difficult to instantly detect misalignment by a visual check.

A method of measuring the position relation between a backlight and a liquid crystal panel is described with reference to FIG. 7. FIG. 7 is a schematic view of a liquid crystal module for explaining a method of measuring the position relation between a backlight and a liquid crystal panel.

FIG. 7(a) is a front view of a liquid crystal module 60, FIG. 7(b) is a side view of the liquid crystal module 60, and FIG. 7(c) is a top view of the liquid crystal module 60.

As shown in FIGS. 7(a) to 7(c), a liquid crystal panel 61 is attached to a backlight 62. Next, the respective lengths of arrows 63a, 63b, 63c, and 63d are measured by using an electron microscope or the like to detect misalignment between the liquid crystal panel 61 and the backlight 62. With this method, it is difficult to instantly detect misalignment by a visual check.

In Patent Document 1, X-ray radiography or the like needs to be performed from the rear side of the mounting substrate so as to detect misalignment, which does not allow for instant detection of misalignment by a visual check. As described above, although conventional techniques for methods of detecting misalignment between a semiconductor chip and a substrate have been disclosed, these methods require a separate device for X-ray radiography or the like to perform a misalignment inspection, and therefore, it was not possible to detect misalignment instantly with a visual check.

In view of such circumstances, the present invention provides a display module that allows for an instant detection of misalignment by a visual check, and also a method for manufacturing such.

### Means For Solving the Problems

In order to solve the above-mentioned problems, a display module of the present invention includes a display unit, a substrate having the display unit on a surface thereof, and a display control unit that controls the display unit to display a mark, wherein the above-mentioned substrate is provided with a mark.

According to the above-mentioned configuration, in manufacturing the display module, by displaying a mark on the display unit, and by comparing the position of that mark with the position of the mark on the substrate, misalignment between the display unit and the substrate can be instantly detected by a visual check.

Also, in manufacturing the display module, the display control unit controls the display unit to display a mark, and by visually checking that mark displayed on the display unit and the mark provided on the substrate, misalignment between the display unit and the substrate can be instantly detected by a visual check.

Further, the mark on the display unit can be easily erased by stopping displaying the mark after the alignment is finished, and therefore, the appearance is not affected.

Thus, it becomes possible to provide a display module in which misalignment is prevented.

A method for manufacturing a liquid crystal module of the present invention includes: a mounting step of mounting a display unit on a substrate that has a mark; and an inspection step of displaying a mark on the display unit after the mounting step and performing an inspection for misalignment between the position of the mark displayed on the display unit and the position of the mark on the substrate.

This makes it possible to instantly confirm proper alignment between the display unit and the substrate by a visual check in an inspection step in the manufacturing process of the display module. Thus, it becomes possible to provide a method for manufacturing a display module that allows for an instant detection of misalignment by a visual check.

### Effects of the Invention

A display module of the present invention includes a display unit, a substrate having the display unit on a surface thereof, and a display control unit that controls the display unit to display a mark, and the substrate is provided with a mark. This results in an effect of making possible an instant detection of misalignment by a visual check.

The method for manufacturing a display module according to the present invention includes a mounting step of mounting a display unit on a substrate that has a mark, and an inspection step of displaying a mark on the display unit after the mounting step, and performing an inspection for misalignment between the position of the mark displayed on the display unit and the position of the mark on the substrate. This results in an effect of making possible an instant detection of misalignment by a visual check.

Additional objects, features, and effects of the present invention shall be readily understood from the descriptions that follow. Advantages of the present invention shall become apparent by the following descriptions with reference to the appended drawings.

### BRIEF DESCRIPTION OF THE DRAWINGS

FIG. 1 is a schematic view of a display module according to an embodiment of the present invention.

FIG. 2 is a schematic view of a display module according to an embodiment of the present invention.

FIG. 3 is a schematic view of a display module according to an embodiment of the present invention.

FIG. 4 is a schematic view of a display module according to an embodiment of the present invention.

FIG. 5 is a schematic view of a display module according to an embodiment of the present invention.

FIG. 6 is a schematic view of a liquid crystal module for explaining a method of measuring the position relation between a protective plate and a liquid crystal panel according to a conventional technology.

FIG. 7 is a schematic view of a liquid crystal module for explaining a method of measuring the position relation between a backlight and a liquid crystal panel according to a conventional technology.

### DETAILED DESCRIPTION OF EMBODIMENTS

### Embodiment 1

### Configuration of Display Module 10

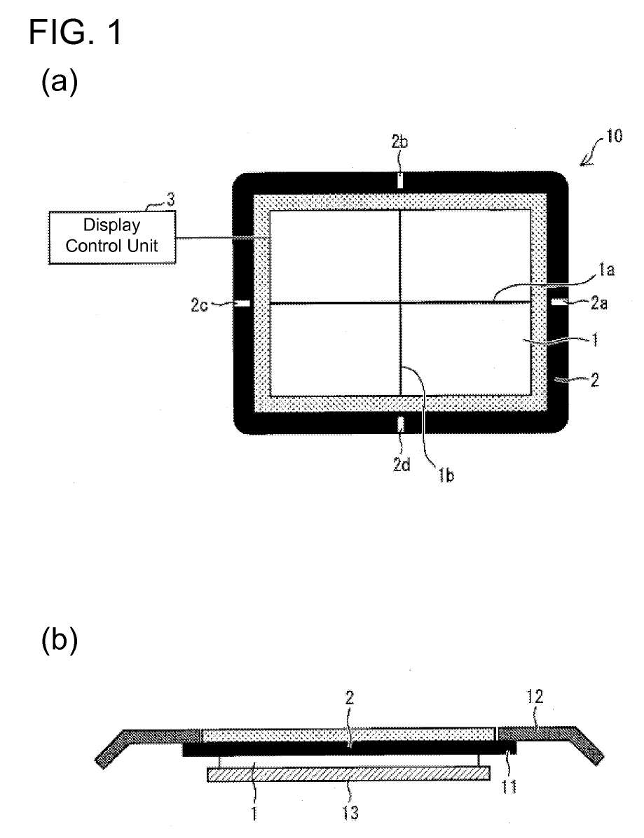

An embodiment of the present invention is described below with reference to FIG. 1. FIG. 1 is a schematic diagram showing a configuration of a display module 10 according to this embodiment. FIG. 1(a) is a front view of the liquid crystal module 10, and FIG. 1(b) is a top view of the liquid crystal module 10.

As shown in FIG. 1, the display module 10 includes a liquid crystal panel 1 (display unit), a protective plate 2 (substrate), and a display control unit 3.

The protective plate 2 is provided on a surface of the liquid crystal panel 1. In the present embodiment, an example in which a liquid crystal panel is used as a display unit included in the display module of the present invention is described, but a plasma panel or an electroluminescence panel may also be used.

The protective plate 2 is a substrate provided for protecting the liquid crystal panel 1. That is, the protective plate is a hardened glass, an acrylic plate, or the like provided in a mobile device such as a mobile phone so as to protect a liquid crystal panel from external shocks. At the periphery of the protective plate, a border of the same color as that of a housing case is printed, that is, when the color of the housing case is black, for example, a black border is printed. The protective plate 2 has alignment marks 2a, 2b, 2c, and 2d (indications). The alignment marks 2a, 2b, 2c, and 2d are linear marks formed in an area outside the liquid crystal panel 1 so as to coincide with straight lines that pass through the respective centers of left, right, top and bottom sides of the protective plate 2 and that are perpendicular to these sides. The protective plate 2 can be made of a hardened glass, acrylic, or the like, for example.

The display control unit 3 controls whether or not an image is displayed on the liquid crystal panel 1, and controls an image that is displayed. Specifically, the display control unit 3 displays a straight line 1a (mark) and a straight line 1b (mark) on the liquid crystal panel 1. The straight line 1a and the straight line 1b are linear marks along straight lines passing through the respective centers of sides of the liquid crystal panel 1 and perpendicular to these sides. In the present embodiment, the display control unit 3 controls the liquid crystal panel 1 so as to display linear marks that respectively connect the centers of respective two sides facing each other in the liquid crystal panel 1, but the linear marks are not limited to such. It is preferable to make the distance between the mark displayed on the display unit in the present invention and the mark on the substrate as small as possible so that it becomes easier to detect misalignment between these marks, for example, and it is more preferable to set the mark displayed on the display unit and the mark on the substrate such that the distance between the two becomes smallest when there is no misalignment between the substrate and the display unit, which makes it even easier to detect misalignment. When the substrate and the display unit have a quadrangular shape and when an alignment mark is provided in one side of the substrate, a linear mark along a straight line passing the center of one side of the display unit, which is closest to the alignment mark, and being perpendicular to that side may be displayed.

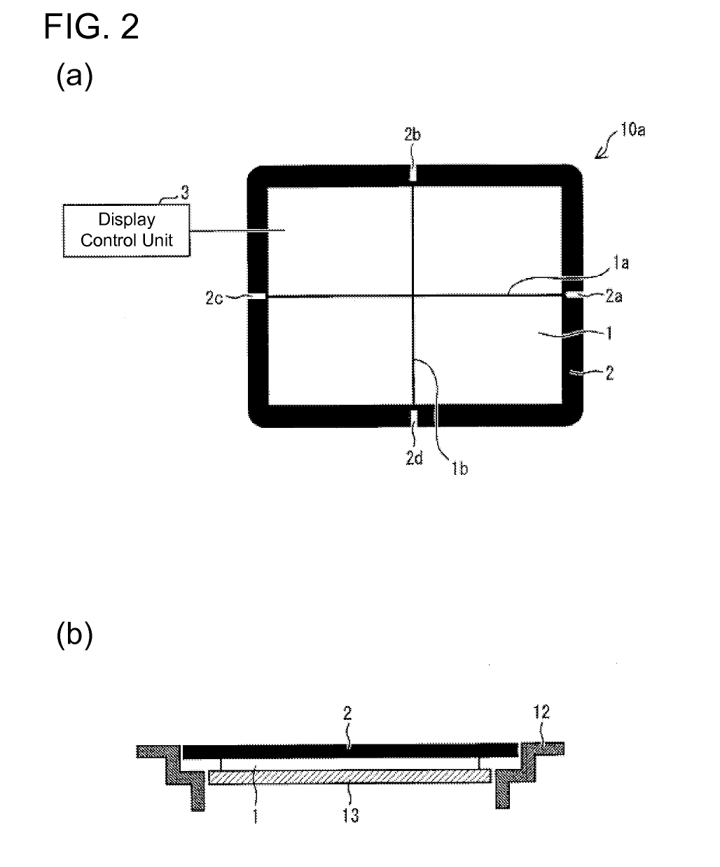

The protective plate generally has one of two shapes: a type with a flange portion; and a type without a flange portion, depending on how the liquid crystal module with a protective plate is inserted to a housing case. In the liquid crystal module 10 of the present embodiment, a flange portion 11 is formed in the protective plate 2. The flange portion 11 is a flanged section that is used when the protective plate 2 and a housing case 12 are bonded to each other. The alignment marks 2a, 2b, 2c, and 2d are provided in the flange portion 11, and therefore, when the protective plate 2 is attached to the housing case 12, because the flange portion 11 is covered by the housing case 12, the alignment marks 2a, 2b, 2c, and 2d become invisible. As a result, the appearance or the visual quality is not compromised. A backlight is represented by 13. A liquid crystal module 10a in the present embodiment in which the flange portion 11 is not formed in the protective plate 2, is described with reference to FIG. 2. FIG. 2(a) is a front view of the liquid crystal module 10a, and FIG. 2(b) is a top view of the liquid crystal module 10a. The liquid crystal module 10a does not include a flange portion, and the protective plate 2 and the housing case 12 are bonded to each other in a manner shown in FIG. 2(b). In this case, the alignment marks 2a, 2b, 2c, and 2d are not covered by the housing case 12.

### Method For Manufacturing Display Module 10

Next, a method for manufacturing the display module 10 is described. The method for manufacturing the display module 10 includes a mounting step of mounting the liquid crystal panel 1 on the protective plate 2 that has the alignment marks 2a, 2b, 2c, and 2d, and an inspection step of displaying the straight line 1a and the straight line 1b on the liquid crystal panel 1 after the mounting step and performing an inspection for misalignment between the positions of straight lines 1a and 1b displayed on the liquid crystal panel 1 and the positions of the alignment marks 2a, 2b, 2c, and 2d on the protective plate 2.

In the mounting step, the liquid crystal panel 1 is mounted on the protective plate 2 having the alignment marks 2a, 2b, 2c, and 2d printed thereon. The liquid crystal panel 1 can be mounted by simply bonding it to the protective plate 2, for example. A bonding technology (air-gapless technology) in which a gap between the protective plate 2 and the liquid crystal panel 1 is filled with an optical resin or an optical double-sided tape may also be used.

After the mounting step, the inspection step is performed. The inspection step is performed to detect misalignment between the liquid crystal panel 1 and the protective plate 2. In this inspection step, misalignment between the positions of the straight lines 1a and 1b displayed on the liquid crystal panel 1 and the positions of the alignment marks 2a, 2b, 2c, and 2d on the protective plate 2 is detected. In other words, the display control unit 3 controls the liquid crystal panel 1 so as to display the straight lines 1a and 1b, and thereafter, whether or not lines extended from the straight lines 1a and 1b respectively match the alignment marks 2a, 2b, 2c, and 2d is checked. If the extended lines of the straight lines 1a and 1b match the alignment marks 2a, 2b, 2c, and 2d, it can be determined that the liquid crystal panel 1 and the protective plate 2 are bonded to each other with no misalignment. If the extended lines of the straight lines 1a and 1b do not match the alignment marks 2a, 2b, 2c, and 2d, it can be determined that the misalignment between the liquid crystal panel 1 and the protective plate 2 occurred in the bonding step. In this manner, misalignment that occurred in the bonding step can be instantly detected by a visual check.

### Embodiment 2

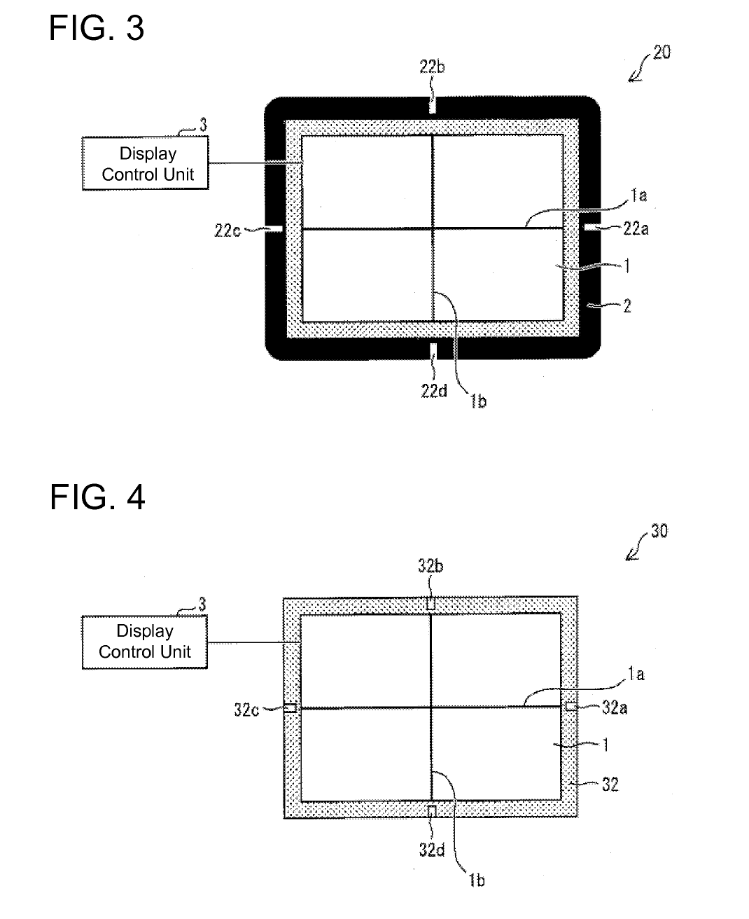

Another embodiment of the present invention is described below with reference to FIG. 3. For convenience of description, the same numbers are given to components having functions similar to those of the components of Embodiment 1, and the descriptions thereof will not be repeated. Below, differences between the present embodiment and Embodiment 1 will be mainly discussed.

A display module 20 according to this embodiment is configured in the same manner as the display module 10 except that, instead of the alignment marks 2a, 2b, 2c, and 2d, cutout portions 22a, 22b, 22c, and 22d (indications) are formed.

In this embodiment, if the extended lines of the straight lines 1a and 1b respectively match the cutout portions 22a, 22b, 22c, and 22d in the inspection step, it can be determined that the liquid crystal panel 1 and the protective plate 2 are bonded with no misalignment. If the extended lines of the straight lines 1a and 1b do not match the cutout portions 22a, 22b, 22c, and 22d, it can be determined that misalignment between the liquid crystal panel 1 and the protective plate 2 occurred in the bonding step. In this manner, misalignment that occurred in the bonding step can be instantly detected by a visual check.

### Embodiment 3

### Configuration of Display Module 30

An embodiment of the present invention is described below with reference to FIG. 4. FIG. 4 is a schematic diagram showing a configuration of the display module 30 according to this embodiment.

As shown in FIG. 4, the display module 30 includes the liquid crystal panel 1 (display unit), a backlight 32 (substrate), and the display control unit 3.

The liquid crystal panel 1 is provided on the backlight 32.

The backlight 32 is a substrate that is used as a light source for the liquid crystal panel 1. The backlight 32 has alignment marks 32a, 32b, 32c, and 32d (indications). The alignment marks 32a, 32b, 32c, and 32d coincide with straight lines that respectively pass through the centers of the left, right, top, and bottom sides of the backlight 32 and that are perpendicular to the respective sides.

The display control unit 3 controls whether or not an image is displayed on the liquid crystal panel 1, and controls an image that is displayed. Specifically, the display control unit 3 displays the straight line 1a (indication) and the straight line 1b (indication) on the display panel 1. The straight line 1a and the straight line 1b are marks along straight lines passing through the respective centers of the sides of the liquid crystal panel 1 and perpendicular to these sides, respectively.

### Method For Manufacturing Display Module 30

Next, a method for manufacturing the display module 30 is described. The method for manufacturing the display module 30 includes a mounting step of mounting the liquid crystal panel 1 on the backlight 32 that has the alignment marks 32a, 32b, 32c, and 32d, and an inspection step of displaying the straight line 1a and the straight line 1b on the liquid crystal panel 1 after the mounting step and performing an inspection for misalignment between the positions of the straight lines 1a and 1b displayed on the liquid crystal panel 1 and the positions of the alignment marks 32a, 32b, 32c, and 32d on the backlight 32.

In the mounting step, the liquid crystal panel 1 is mounted on the backlight 32 that has the alignment marks 32a, 32b, 32c, and 32d printed thereon. The liquid crystal panel 1 can be mounted by simply bonding it to the backlight 32, for example.

After the mounting step, the inspection step is performed. The inspection step is performed to detect misalignment between the liquid crystal panel 1 and the backlight 32. In this inspection step, misalignment between the positions of the straight lines 1a and 1b displayed on the liquid crystal panel 1 and the positions of the alignment marks 32a, 32b, 32c, and 32d on the backlight 32 is detected. In other words, the display control unit 3 controls the liquid crystal panel 1 so as to display the straight lines 1a and 1b, and thereafter, whether or not lines extended from the straight lines 1a and 1b respectively match the alignment marks 32a, 32b, 32c, and 32d is checked. If the extended lines of the straight lines 1a and 1b match the alignment marks 32a, 32b, 32c, and 32d, it can be determined that the liquid crystal panel 1 and the backlight 32 are bonded with no misalignment. If the extended lines of the straight lines 1a and 1b do not match the alignment marks 32a, 32b, 32c, and 32d, it can be determined that misalignment between the liquid crystal panel 1 and the backlight 32 occurred in the bonding step. In this manner, misalignment that occurred in the bonding step can be instantly detected by a visual check.

### Embodiment 4

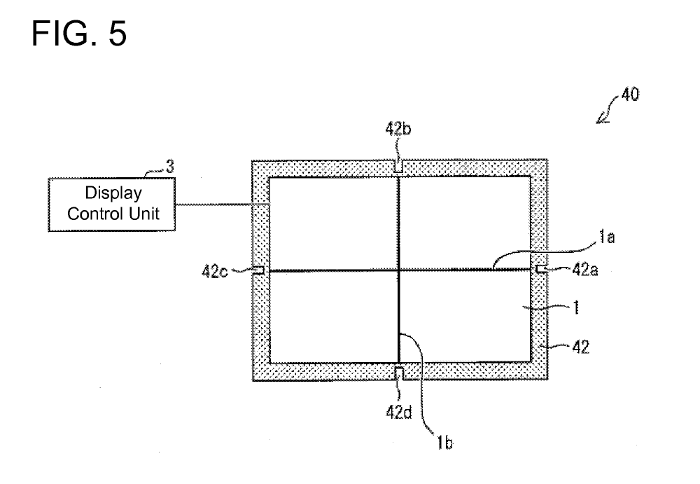

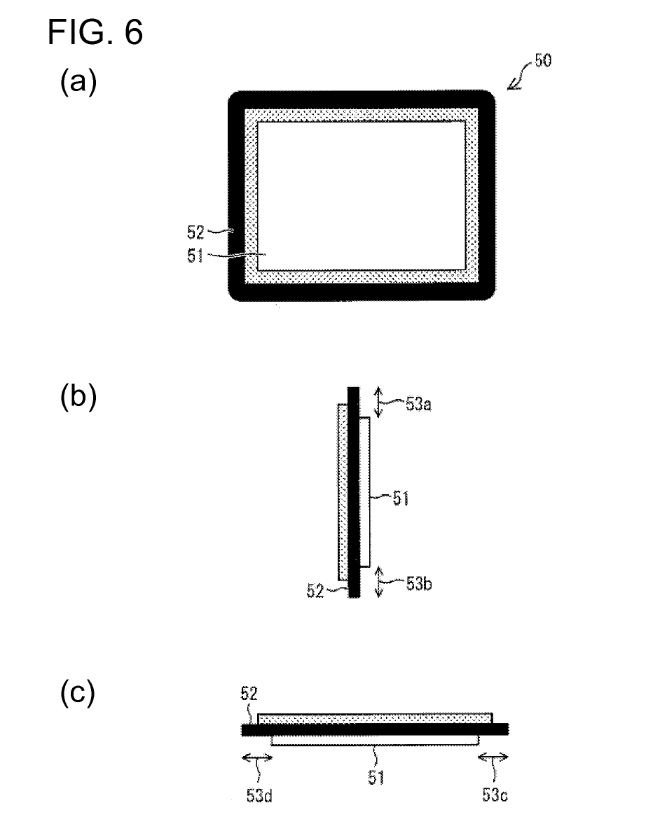

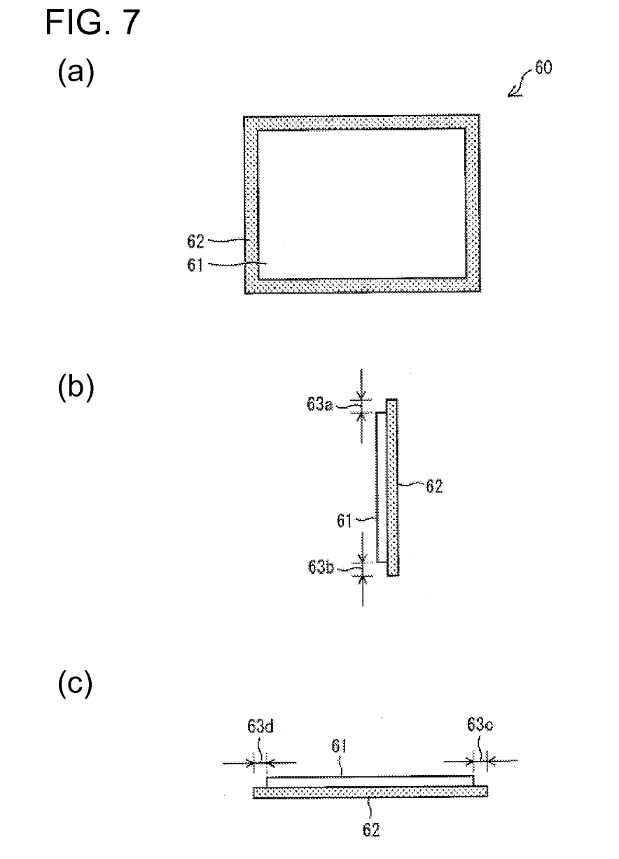

Another embodiment of the present invention is described below with reference to FIG. 5. For convenience of description, the same numbers are given to components having functions similar to those of the components of Embodiment 3, and the descriptions thereof will not be repeated. Below, differences between the present embodiment and Embodiment 3 will be mainly discussed.

A display module 40 according to this embodiment is configured in the same manner as the display module 30 except that, instead of the alignment marks 32a, 32b, 32c, and 32d, cutout portions 42a, 42b, 42c, and 42d (indications) are formed.

In this embodiment, if the extended lines of the straight lines 1a and 1b respectively match the cutout portions 42a, 42b, 42c, and 42d in the inspection step, it can be determined that the liquid crystal panel 1 and the backlight 32 are bonded to each other with no misalignment. If the extended lines of the straight lines 1a and 1b do not match the cutout portions 42a, 42b, 42c, and 42d, it can be determined that misalignment between the liquid crystal panel 1 and the backlight 42 occurred in the bonding step. In this manner, misalignment that occurred in the bonding step can be instantly detected by a visual check.

The present invention is not limited to the respective embodiments described above. Various modifications can be made without departing from the scope defined by the claims, and embodiments that can be obtained by appropriately combining technical features disclosed in different embodiments are also included in the technical scope of the present invention.

### Additional Descriptions

In the display module according to the present invention, it is more preferable to set the mark on the substrate and the mark displayed on the display unit such that the distance between the two becomes smallest when the substrate and the display unit are bonded to each other with no misalignment.

When the marks displayed on the display unit and the marks on the substrate are closely located, it becomes easier to see misalignment between the respective marks, which makes it easier to perform the misalignment inspection. Thus, it becomes possible to provide a display module that can suppress misalignment in a simpler manner.

In the display module according to the present invention, it is more preferable that: the display unit and the substrate have a quadrangular shape; the marks on the substrate be provided in an area outside the display unit so as to coincide with straight lines that pass through the centers of the respective sides of the substrate and that are perpendicular to these sides; and the display control unit control the display unit to display a linear mark that overlaps the center of one side, which is closest to the mark on the substrate, among the sides of the display unit and that is perpendicular to the side.

This way, misalignment can be detected by visually checking the distance between the extended line of the linear mark displayed on the display unit and the marks on the substrate, which makes it even easier to perform the misalignment inspection. Thus, it becomes possible to provide a display module that can suppress misalignment in a simpler manner.

In the display module according to the present invention, it is more preferable that: the display unit and the substrate have a quadrangular shape; the marks on the substrate be provided in an area outside the display unit so as to coincide with straight lines that pass through the centers of the respective sides of the substrate and that are perpendicular to these sides; and the display control unit control the display unit to display linear marks that respectively connect the centers of sides that are facing each other in the display unit.

By visually checking the distance between the extended lines of the linear marks, which are displayed on the display unit and respectively connect the centers of sides that are facing each other in the display unit, and the marks on the substrate, the more accurate misalignment inspection can be performed in a simpler manner. Thus, it becomes possible to provide a display module that can more accurately suppress misalignment in a simpler manner.

In the display module of the present invention, the substrate may be a protective plate of the display unit.

This makes it possible to instantly detect misalignment between the protective plate and the liquid crystal panel in the display module by a visual check.

The display unit may be a liquid crystal display unit, and the substrate may be a backlight.

This makes it possible to instantly detect misalignment between the backlight and the liquid crystal panel in the display module by a visual check.

The specific embodiments and examples described in the section of the detailed description of the invention are provided only to explain the technical content of the present invention, and the present invention should not be narrowly interpreted by limiting the scope thereof to such specific examples. Various modifications can be made without departing from the spirit and scope of the claims of the present invention provided below.

### INDUSTRIAL APPLICABILITY

A display module of the present invention and a method for manufacturing the same can be suitably used for a display module, such as a liquid crystal display, a plasma display, and an electroluminescent display, and the like.

### DESCRIPTION OF REFERENCE CHARACTERS

1 liquid crystal panel (display unit)

1a, 1b straight line (indication)

2 protective plate (substrate)

2a, 2b, 2c, 2d alignment mark (indication)

3 display control unit

11 flange portion

12 housing case

13 backlight

22a, 22b, 22c, 22d alignment mark (indication)

32a, 32b, 32c, 32d alignment mark (indication)

42a, 42b, 42c, 42d alignment mark (indication)

10 display module

10a display module

20 display module

30 display module

40 display module

1. A display module, comprising:
a display unit;
a substrate having said display unit on a surface thereof; and
a display control unit that controls said display unit so as to display a mark,
wherein said substrate is provided with a mark.

2. The display module according to claim 1, wherein a distance between the mark on said substrate and the mark displayed on said display unit becomes smallest when said substrate and said display unit are not misaligned to each other.

3. The display module according to claim 1, wherein said display unit and said substrate have a quadrangular shape,
wherein the mark on said substrate is provided in an area outside said display unit so as to coincide with a straight line that passes through a center of a side of said substrate and that is perpendicular to said side, and
wherein said display control unit controls said display unit to display a linear mark along a straight line passing through a center of one side of said display unit closest to the mark on said substrate among sides of said display unit, and being perpendicular to said side.

4. The display module according to claim 1, wherein said display unit and said substrate have a quadrangular shape,
wherein the mark on said substrate is provided in an area outside said display unit so as to coincide with a straight line that passes through a center of a side of said substrate and that is perpendicular to said side, and
wherein said display control unit controls said display unit to display a linear mark that connects respective centers of sides facing each other in said display unit.

5. The display module according to claim 1, wherein said substrate is a protective plate of said display unit.

6. The display module according to claim 1, wherein said display unit is a liquid crystal display unit, and said substrate is a backlight.

7. A method for manufacturing a display module, comprising:
a mounting step of mounting a display unit on a substrate that is provided with a mark; and
an inspection step of displaying a mark on said display unit after said mounting step, and performing an inspection for misalignment between a position of the mark displayed on said display unit and a position of the mark on said substrate.
